(19) United States
(12) Patent Application Publication
(10) Pub. No.: US 2014/0288964 A1
(43) Pub. Date: Sep. 25, 2014

(54) Method And System For Supporting An Acquisition Of Clinical Data

(71) Applicant: SIEMENS AKTIENGESELLSCHAFT, Munchen (DE)

(72) Inventor: Sonja Zillner, Munchen (DE)

(73) Assignee: Siemens Aktiengesellschaft, Munchen (DE)

(21) Appl. No.: 13/848,915

(22) Filed: Mar. 22, 2013

(51) Int. Cl. G06F 19/00

(52) U.S. Cl. CPC G06F 19/36
USPC 705/3

(57) ABSTRACT

A method for supporting an acquisition of clinical data may include the steps of: receiving, by an input component, an identifier characterizing a health state of a patient; accessing a diagnose process model associated to said identifier, the diagnose process model specifying a sequence of clinical treatments whereby each of said clinical treatments includes at least one information model; sequentially activating information models from at least one of said clinical treatments by said process model; requesting, by each of said activated information models, at least one data unit; extracting an information unit by applying an information extraction method to said data unit and interpreting the information unit by reasoning and mapping the information unit to at least one knowledge model; and sequentially instantiating at least one information model by a plurality of said information units.

### TECHNICAL FIELD

The present disclosure relates to a method for acquisition of clinical data. More specifically, the present disclosure relates to a method aiming to improve comprehensiveness of clinical data at the time of acquiring this data.

### BACKGROUND

The advent of digital communication has fundamentally changed manners of acquiring clinical data by clinical personnel. Widely accepted usage of computers in the clinical field not-withstanding, the general process of clinical data acquisition has almost predominantly remained paper-based, so that a seamless exchange of data is hindered by breaches in a digital work-flow. It is still common practice amongst clinical experts to exchange patient data by scanning and emailing or faxing paper documents. Accordingly, there is a need in the art of providing clinical information which is capable of being exchanged in a digital work-flow.

Although information in the clinical field does not specifically differ from information in other fields, the fact none the less remains that clinical or medical data are highly complex. Often—for instance when analyzing clinical data with the purpose of conducting retrospective studies—one recognizes that particular but important parameters are missing within the collected data sets. In other words, the data collected in clinical routines are usually not complete or particular parameters are not documented as they had not been relevant for a particular case. However, such parameters might be of high relevance when one aims to compare patients and patient groups in the context of retrospective studies or analytical applications. Accordingly, there is a need in the art of providing comprehensive clinical information—ideally starting from the very beginning, at a time when clinical data are entered into a repository system.

Only in rare cases longitudinal data are captured. Longitudinal data in the clinical context means systematic and comprehensive collection of data over time. In current practice, however, data are usually only collected in the context of a particular episode of a patient's treatment. Although the documentation of longitudinal patient health data is very promising in terms of future data analytics, it is currently only accomplished for rare or severe disease. However, an acquisition of longitudinal data is still accomplished unsystematically. Usually, longitudinal data are acquired in the course of medical studies. So much the worse, the process of acquiring longitudinal data is often implemented as parallel track to clinical routine processes in an ad-hoc manner.

### SUMMARY

Systems and methods in accordance with various embodiments of provide for an acquisition of clinical data.

In one embodiment, a method for is disclosed, including the steps of:
a) receiving, by an input component, an identifier characterizing a health state of a patient;
b) accessing a diagnose process model associated to said identifier, the diagnose process model specifying a sequence of clinical treatments whereby each of said clinical treatments includes at least one information model;
c) sequentially activating information models from at least one one of said clinical treatments by said process model;
d) requesting, by each of said activated information models, at least one data unit;
e) extracting an information unit by applying an information extraction method to said data unit and interpreting the information unit by reasoning and mapping the information unit to at least one knowledge model; and;
f) sequentially instantiating at least one information model by a plurality of said information units.

According to an embodiment, clinical treatments include complex clinical treatments and simple clinical treatments. A simple clinical treatment includes one information model, whereas a complex clinical treatment may include a plurality of information models. Further on, a complex clinical treatment may include nested clinical treatments, which means that a complex clinical treatment may comprise further complex clinical treatments and/or simple clinical treatments.

By a simple clinical treatment, one information model is activated. The information model activated by a simple clinical treatment usually requests one data unit. This data unit is a basic data acquisition unit which is specified by the associated information model that determines the categories or parameters needed to be documented within this particular simple clinical treatment. An exemplary clinical treatment is an examination step for which the results of a complete or a partial blood count are required. These results are entered by a data unit.

According to another embodiment, a system for supporting an acquisition of clinical data is disclosed, the system including:
an input component for receiving an identifier characterizing a health state of a patient;
an information extraction unit for accessing a diagnose process model associated to said identifier, the diagnose process model specifying a sequence of clinical treatments whereby each of said clinical treatments includes at least one information model, the information extraction unit further adapted for sequentially activating information models from at least one of said clinical treatments by said process model, whereby by each of said activated information models, at least one data unit is requested; the information extraction unit further adapted for extracting an information unit by applying an information extraction method to said data unit and interpreting the information unit by reasoning and mapping the information unit to at least one knowledge model; and, the information extraction unit further adapted for sequentially instantiating at least one information model by a plurality of said information units.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWING

The objects as well as further advantages of certain embodiments will become more apparent and readily appreciated from the following description in conjunction with the accompanying drawing accompanying drawing of which:

FIG. 1 shows a flow chart of a method for supporting an acquisition of clinical data according to one embodiment; and;

FIG. 2 shows a block diagram of a system for implementing an acquisition of clinical data according to a further exemplary embodiment.

### DETAILED DESCRIPTION

The process of acquisition of clinical data is triggered, for example, by a patient that sees a doctor and a disease is diagnosed or an initial suspicion of a disease is documented. According to the assumed disease, which may be recorded by an identifier like a DRG-code (diagnose related group), more information related to the health status of the patient needs to be acquired, and respectively more clinical treatments or examination steps need to be conducted. Today, all the required information is collected in an unsystematic way. The communication and sharing of information involves the cooperation of several parties and each hospital solves the data collection challenge in its own way relying on more or less efficient routines.

Today the underlying data acquisition processes is neither supported nor standardized. Often the collection of data is still paper-based, and the sharing and exchange of examination result is accomplished by scanning and emailing or directly faxing such paper-based report.

Some embodiments are directed to establish means for the automated guidance and support in the process of clinical data acquisition. Comprehensive clinical data sets are of great value for improved quality and efficiency of clinical care.

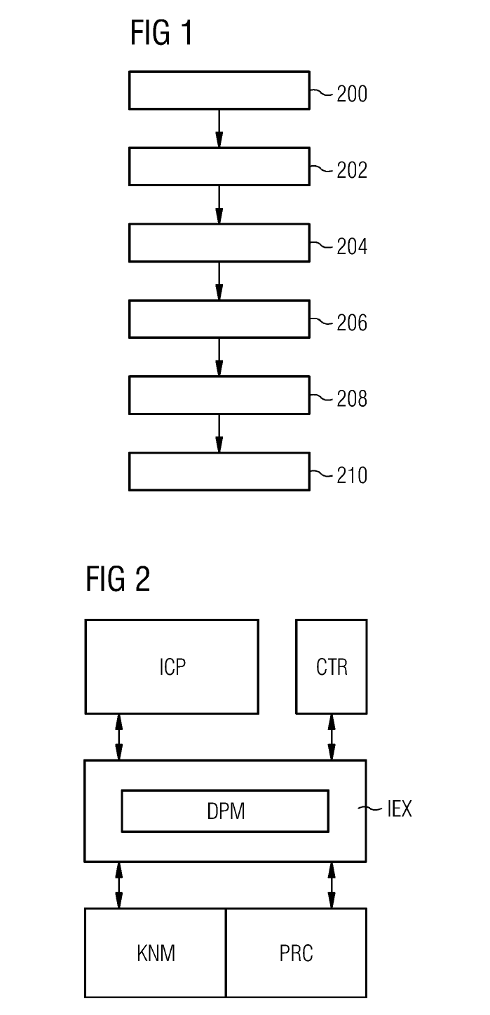

FIG. 1 illustrates a flow chart of a method for supporting an acquisition of clinical data according to one embodiment.

In a first step 200 an identifier is received by an input component. The identifier is characterizing a health state of a patient. According to an embodiment, the identifier may include a DRG-code or any other related formal coding information which specifies the initial suspicion of a disease or symptom of a patient. According an embodiment, the identifier determines subsequent clinical treatments or examination steps, which are often referred to as clinical or critical pathways or clinical guidelines.

In a subsequent step 202 a diagnose process model is accessed, whereby the diagnose process model is associated with said identifier. The diagnose process model specifies a sequence of clinical treatments whereby each of these clinical treatments includes at least one information model. In other words a particular process model is accessed, which is associated with a disease suspicion, clinical guidelines and pathways, all referenced by the identifier.

According to an embodiment, a diagnose process model may comprise a sequence of clinical treatments, as well as associated information models and meta-models. In accordance with the specified sequence of clinical treatments, the related information models as well as the related meta-models, the user interaction and dialogue are provided and organized by the system.

In a subsequent step 204 the process model activates information models in a sequential manner. Each information model is assigned to at least one of said clinical treatments.

In a subsequent step 206 each of said activated information models requests at least one data unit. This process of requesting data units is, again, implemented in a sequential manner. Data units are requested from a user or retrieved from a patient record by the input component. A specific user dialogue for requesting the data units is determined by the specific underlying information model. In anticipation of the description of final step 210, data units are sequentially requested until the information model is completely populated, or instantiated, with instance data.

According to an embodiment, for each information category, a user is requested to provide corresponding information by a data unit. An exemplary data unit could be captioned by the request [symbol] What is the blood pressure of the patient? [symbol] . The data unit for this request can be delivered by a dedicated speech module or by a structured template indicating the information request. An answer provided by the user is captured by the input component which transforms the provided input into a data unit which is suitable for further processing.

In a subsequent step 208 an information unit is extracted by applying an information extraction method to the data unit. In parallel, the information unit is and interpreted by reasoning and mapping the information unit to at least one knowledge model. The process of extraction and interpretation is sequentially applied, e.g., for each of the received data units. This step might be characterized as an interpretation step. The machine-based interpretation of the information provided by the data unit is determined by at least one implemented information extraction module. According to an embodiment, the information extraction module is supported by associated information models and meta-models, and, optionally, by associated disease models.

Information models, meta models, as well as disease models specify which information unit (e.g. blood pressure) is requested. Further on, said models specify which information units are likely or related (e.g. coffee consumption, climbing stairways, drug that influences blood pressure, typical symptoms known due to the disease models). The information extraction modules are using this context and background information to improve their own precision and recall performance values.

In a final step 210 the information model, or a plurality of information models, are sequentially instantiated by the plurality of information units.

FIG. 2 illustrates some basic components of a system for supporting an acquisition of clinical data according to one embodiment.

An input component ICP receives data units by a user dialogue from a human operator or by an automated retrieval from a patient record.

The data unit comprises text-based, speech or image-based data information. Accordingly, the input component ICP may comprises speech recognition, enabling a user to dictate textual contents whereby the speech recognition transforms the dictated text into an accessible text. Further on, the input component ICP can rely on multiple modalities, i.e. cameras that record particular movement or gestures that again are interpreted by the system accordingly. Further, the input component ICP may support a stylus or a digital pen that etc.

As a commonality for all input modalities, the input component ICP processes various types of input (speech, text, gesture, etc.) and transforms this input into accessible text for usage within the further processing steps.

The data units are transferred between the input component and an information extraction module IEX.

The information extraction module IEX makes use of a diagnose process model DPM along other optional knowledge models KNM, including disease models and/or medical knowledge models. A particular diagnose process models DPM is accessed for particular a disease or symptom, for instance breast cancer, pregnancy, lymphoma or an initial clinical suspicion of a particular disease or symptom.

For each clinical treatment, e.g. examination step, and for each information model, a dedicated and adjusted information extraction module is provided. Each particular diagnose process model DPM details a particular sequence of clinical treatments, e.g. examination steps, required to accomplish the proceeding diagnose decision or are part of a required monitoring task. Examination steps can be simple or complex. Complex examination steps include a sequence of complex and simple examination steps.

A simple examination step is requesting a basic data unit which is specified by an associated information model that determines the categories and/or parameters needed to be documented within this particular simple examination step.

The semantics of each information model is again specified by an associated meta-model specifying for each information model how its information, e.g. categories or parameters, are labeled. This means that an information model specifies for each information category the associated concept of a suitable standardized medical knowledge model. Alternatively, a plurality of concepts is associated so that an information model specifies for each information category a plurality of associated concepts delivered by at least one suitable standardized medical knowledge model.

According to an embodiment, the knowledge models KNM include at least one disease model and at least one medical knowledge model. Each disease model is provided for a particular disease, e.g. lymphoma. The disease models capture any relevant medical background information of the particular disease available in clinical text books that can be formally described. For instance, such models encompass the information about typical symptoms of the disease, leading symptoms, risk groups, risk behavior, information about the differential diagnosis, synonyms, and so on. Medical knowledge models, in turn, capture commonly agreed medical ontologies and standards that are suitable for semantically annotating captured patient data.

The information extraction module IEX, which is closely aligned with the diagnose process model DPM, is operated to extract an information unit by applying an information extraction method to the data unit transferred by the input component ICT. Specifically, the information extraction module IEX transforms unstructured data captured by the input component ICP into semantically annotated structured data. According to one embodiment, the information extraction method is based on NLP technologies (natural language process).

According to a further optional embodiment, an electronic patient record repository PRC is provided. The electronic patient record repository PRC is a dedicated storage unit that is used for storing patient data of any examination and treatment step. In addition, the electronic patient record stores any other data, such as observations, that is related to the patient's health status.

According to a further optional embodiment, a controlling unit CTR is provided. The controlling unit CTR may be implemented as a dedicated user interaction module that automatically triggers an approval step, i.e. by a human user, while or after processing the clinical data. The controlling unit CTR ensures that any patient data captured is approved and controlled by a medical expert.

The information unit is interpreted by reasoning and mapping the information unit to at least one concept of the knowledge models KNM.

By a sequential process, an information model—not shown—is instantiated by a plurality of information units.

Some embodiments establish an approach for an automated support of the overall process of clinical data acquisition.

Some embodiments aim to acquire comprehensive clinical data sets of patients and patient populations suitable for longitudinal clinical data, i.e. a systematic and comprehensive collection of data over time. A comprehensive set of clinical data is an important prerequisite for advanced health data analytics applications, such as comparative effective research, patient profiling, and advanced clinical decision support applications.

Advantageous embodiments integrate a high degree of context and background information in order to improve the precision of existing information extraction technologies.

Advantageous embodiments make use of a comprehensive treatment process model as well as a disease model which precisely specify at which point in time which type of information —parameters or categories—are supposed to be collected in order to achieve a comprehensive patient data repository at the end of the process.

Some embodiments can be implemented in computing hardware (computing apparatus) and/or software, including but not limited to any computer or microcomputer that can store, retrieve, process and/or output data and/or communicate with other computers. For example, the input component and the information extraction module may be embodied as software or other computer-readable instructions stored in a memory device or other non-transitory computer-readable media and executable by a microprocessor or other processing device to provide the various functionality disclosed herein.

The processes can also be distributed via, for example, down-loading over a network such as the Internet. A program/software implementing the embodiments may be recorded on computer-readable media comprising computer-readable recording media. The program/software implementing the embodiments may also be transmitted over a transmission communication media such as a carrier wave.

The invention has been described in detail with particular reference to example embodiments thereof and examples, but it will be understood that variations and modifications can be effected within the spirit and scope of the invention covered by the claims.

What is claimed is:

1. A computer-implemented method for supporting an acquisition of clinical data, the computer-implemented method facilitated by a processor executing computer instructions stored in non-transitory computer readable media and including the steps of:
the processor receiving via an input component, an identifier characterizing a health state of a patient;
the processor accessing a diagnose process model associated to said identifier, the diagnose process model specifying a sequence of clinical treatments whereby each of said clinical treatments includes at least one information model;
the processor sequentially activating information models from at least one of said clinical treatments by said process model;
the processor requesting, by each of said activated information models, at least one data unit;
the processor extracting an information unit by applying an information extraction method to said data unit and interpreting the information unit by reasoning and mapping the information unit to at least one knowledge model; and
the processor sequentially instantiating at least one information model by a plurality of said information units.

2. The method according to claim 1, whereby the at least one data unit is requested by a user dialogue or by retrieving a patient record.

3. The method according to claim 1, said clinical treatments including complex clinical treatments and simple clinical treatments, the complex clinical treatments including at least one of a sequence of simple clinical treatments and further complex clinical treatments.

4. The method according to claim 3, said simple clinical treatment includes one of said information models.

5. The method according to claim 4, said information model determining information to be documented within said simple clinical treatment.

6. A system for supporting an acquisition of clinical data including, the system including:
an input component for receiving an identifier characterizing a health state of a patient;
an information extraction unit for accessing a diagnose process model associated to said identifier, the diagnose process model specifying a sequence of clinical treatments whereby each of said clinical treatments includes at least one information model;
the information extraction unit further adapted for sequentially activating information models from at least one of said clinical treatments by said process model, whereby by each of said activated information models, at least one data unit is requested;
the information extraction unit further adapted for extracting an information unit by applying an information extraction method to said data unit and interpreting the information unit by reasoning and mapping the information unit to at least one knowledge model; and
the information extraction unit further adapted for sequentially instantiating at least one information model by a plurality of said information units;
wherein the input component and the information extraction module are be embodied as computer-readable instructions stored in non-transitory computer-readable media and executable by a processor to provide the respective functions.

7. A computer program product comprising program code stored on a non-transitory computer-readable medium and which, when executed on a computer, is configured to:
receive via an input component, an identifier characterizing a health state of a patient;
access a diagnose process model associated to said identifier, the diagnose process model specifying a sequence of clinical treatments whereby each of said clinical treatments includes at least one information model;
sequentially activate information models from at least one of said clinical treatments by said process model;
request, by each of said activated information models, at least one data unit;
extract an information unit by applying an information extraction method to said data unit and interpreting the information unit by reasoning and mapping the information unit to at least one knowledge model; and
sequentially instantiate at least one information model by a plurality of said information units.
